(19) United States
(12) Patent Application Publication
(10) Pub. No.: US 2008/0194724 A1
(43) Pub. Date: Aug. 14, 2008

(54) METHOD OF FORMING A CROSSLINKED POLY(ARYLENE ETHER) FILM, AND FILM FORMED THEREBY

(76) Inventors: Pankaj Singh Gautam, Evansville, IN (US); Edward Norman Peters, Lenox, MA (US); Gerardo Rocha-Galicia, Clifton Park, NY (US)

Correspondence Address: CANTOR COLBURN LLP - SABIC (NORYL), 20 Church Street, 22nd Floor, Hartford, CT, 06103, US

(21) Appl. No.: 11/673,806

(22) Filed: Feb. 12, 2007

(51) Int. Cl. C08J 7/02

(52) U.S. Cl. 522/80; 522/181; 522/71; 522/74

(57) ABSTRACT

A crosslinked poly(arylene ether) film is prepared by a method that includes forming a film from a composition that includes a poly(arylene ether) having an intrinsic viscosity of at least 0.25 deciliter per gram and a polydispersity index less than or equal to 10, and irradiating the poly(arylene ether) film with a dosage of about 50 to about 50,000 kiloGrays of accelerated electrons. The films exhibit good flexibility and solvent resistance. Films prepared by the method are described, as are articles that include such films.

### BACKGROUND OF THE INVENTION

The current trend in the microelectronics is toward increasing miniaturization of components and increasing frequencies of operation. The miniaturization of circuits typically results in closer spacing of the conductive traces and an increase in the aspect ratio (length/thickness) of the conductive traces. These twin factors cause inductive cross-talk and capacitive effects that decrease the reliability of data transport. Furthermore, higher circuit density results in an increase in the signal delay such that it is the main contributor to the overall signal delay time for sub-micron size devices. The use of an insulating material having a low dielectric constant can help in reducing signal delay and mitigating cross-talk between conductive traces. In addition, use of an insulating material having a low dissipation factor can reduce signal transmission losses to the insulator and thereby reduce heat generation, especially for high frequency applications. The proper disposal of excess heat assumes greater importance for components having small device sizes.

Poly(arylene ether) resin is a type of plastic known for its excellent water resistance, dimensional stability, and inherent flame retardancy. Poly(arylene ether) has a low dielectric constant and very low dissipation factor compared to many other materials in use as insulators. However, it has comparatively lower heat resistance so it typically cannot withstand the multiple soldering operations used in microelectronic fabrication. One of the ways to increase the heat resistance of a poly(arylene ether) is to incorporate polymerizable groups into the poly(arylene ether) and then crosslink them. Crosslinking of poly(arylene ether)s with polymerizable groups is usually effected by thermal curing. When thermal curing is conducted in the presence of a polymerization initiator, such as an organic peroxide, it is sometimes referred to as thermochemical curing. However, thermal and thermochemical curing both require elevated temperatures and extended processing times, and the resulting crosslinked films are often brittle. Poly(arylene ether) films have also been crosslinked with ionizing radiation. For example, U.S. Pat. No. 3,373,226 to Gowan describes crosslinking poly(2,6-dimethyl-1,4-phenylene)oxide with x-rays. However, the use of ionizing radiation typically requires the handling of radioactive sources, and, like thermal curing, it typically requires extended processing times.

There is therefore a need for a method of forming crosslinked poly(arylene ether) films that allows for fast processing times, produces flexible films, and avoids high processing temperatures and the handling of radioactive sources.

### BRIEF DESCRIPTION OF THE INVENTION

The above-described and other drawbacks are alleviated by a method of preparing a crosslinked poly(arylene ether) film, comprising: forming a poly(arylene ether) film from a composition comprising a poly(arylene ether) having an intrinsic viscosity of at least 0.25 deciliter per gram measured at 25° C. in chloroform, and a polydispersity index less than or equal to 10; and irradiating the poly(arylene ether) film with a dosage of about 50 to about 50,000 kiloGrays of accelerated electrons to form a crosslinked poly(arylene ether) film.

Another embodiment is a method of preparing a crosslinked poly(arylene ether) film, comprising: solvent casting a composition comprising about 60 to about 90 weight percent chloroform, and about 10 to about 40 of a poly(2,6-dimethyl-1,4-phenylene ether-co-2-allyl-6-methyl-1,4-phenylene ether) having an intrinsic viscosity of about 0.35 to about 1 deciliter per gram and a polydispersity index of about 2 to about 6 to form a poly(arylene ether) film; and irradiating the poly(arylene ether) film with a dosage of about 1,000 to about 10,000 kiloGrays of accelerated electrons.

Other embodiments, including crosslinked poly(arylene ether) films prepared by the methods and articles comprising such films, are described in detail below.

### DETAILED DESCRIPTION OF THE INVENTION

The present inventors have found that crosslinked poly(arylene ether) films exhibiting improved flexibility may be prepared by a method that utilizes a particular dosage of electron beam curing and a poly(arylene ether) having particular molecular weight characteristics. Specifically, the flexibility of the crosslinked film is substantially improved when the poly(arylene ether) has an intrinsic viscosity of at least 0.25 deciliter per gram and a polydispersity index less than or equal to 10, and when the poly(arylene ether) film is crosslinked with a dosage of about 50 to about 50,000 kiloGrays of accelerated electrons. Thus, one embodiment is a method of preparing a crosslinked poly(arylene ether) film, comprising: forming a poly(arylene ether) film from a composition comprising a poly(arylene ether) having an intrinsic viscosity of at least 0.25 deciliter per gram measured at 25° C. in chloroform, and a polydispersity index less than or equal to 10; and irradiating the poly(arylene ether) film with a dosage of about 50 to about 50,000 kiloGrays of accelerated electrons to form a crosslinked poly(arylene ether) film. Films prepared by the method are particularly suitable for use as insulating materials in the fabrication of microelectronic devices.

The method comprises forming a poly(arylene ether) film. Suitable film-forming methods include melt extrusion, solvent casting, spin coating, roller coating, dipping, spraying, and the like. When melt extrusion is used, the film-forming composition is typically solvent free. When solvent casting is used, the film-forming composition comprises solvent. Other film-forming methods may or may not utilize solvent in the film-forming composition. Suitable solvents are discussed below.

The method is suitable for forming crosslinked poly(arylene ether) films having a wide variety of thicknesses. For example, the crosslinked poly(arylene ether) film may have a thickness of about 1 to about 1,000 micrometers, specifically about 5 to about 300 micrometers, more specifically about 10 to about 100 micrometers. Film thickness can be determined using methods and equipment known in the art. For example, film thickness can be measured using a Mitutoyo Series 293-330 micrometer that has a ratchet mechanism for taking accurate readings of film thickness without compressing the film. Film thickness can be measured at four corners and center of a film sample and averaged.

The film-forming composition comprises a poly(arylene ether) having an intrinsic viscosity of at least 0.25 deciliter per gram measured at 25° C. in chloroform. In some embodiments, the poly(arylene ether) intrinsic viscosity is 0.25 to about 1 deciliter per gram, specifically about 0.3 to about 0.8 deciliter per gram, more specifically about 0.35 to about 0.6 deciliter per gram. When the intrinsic viscosity of the poly(arylene ether) is less than 0.25 deciliter per gram, the flexibility of the resulting crosslinked film may be insufficient.

The poly(arylene ether) used in the film-forming composition has a polydispersity index less than or equal to 10. In some embodiments, the polydispersity index is 1 to 10, specifically about 1.5 to about 8, more specifically about 2 to about 6, even more specifically about 2 to about 5, still more specifically about 2 to about 4, yet more specifically about 2 to about 3.5, even more specifically about 2 to about 3. When the polydispersity index is greater than 10, the flexibility of the resulting crosslinked film may be insufficient.

A wide variety of poly(arylene ether) structures are suitable for use in the method. In some embodiments, the poly(arylene ether) comprises repeating structural units having the formula

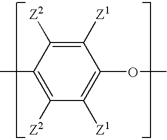

wherein for each structural unit, each Z¹ is independently halogen, unsubstituted or substituted C₁-C₁₂ hydrocarbyl provided that the hydrocarbyl group is not tertiary hydrocarbyl, C₁-C₁₂ hydrocarbylthio (that is, (C₁-C₁₂ hydrocarbyl)S—), C₁-C₁₂ hydrocarbyloxy, or C₂-C₁₂ halohydrocarbyloxy wherein at least two carbon atoms separate the halogen and oxygen atoms; and each Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. The hydrocarbyl residue, when so stated however, may contain heteroatoms over and above the carbon and hydrogen members of the substituent residue. Thus, when specifically noted as containing such heteroatoms, the hydrocarbyl residue may also contain one or more carbonyl groups, amino groups, hydroxyl groups, or the like, or it may contain heteroatoms within the backbone of the hydrocarbyl residue. As one example, Z¹ may be a di-n-butylaminomethyl group formed by reaction of a terminal 3,5-dimethyl-1,4-phenyl group with the di-n-butylamine component of an oxidative polymerization catalyst.

In some embodiments, the poly(arylene ether) comprises at least one polymerizable group. Polymerizable group include, for example, acryloyl groups (—C(═O)CH═CH₂), methacryloyl groups (—C(═O)CH(CH₃)═CH₂), vinyl groups (—CH═CH₂), ethynyl groups (—C≡CH), allyl groups (—CH₂CH═CH₂), propargyl groups (—CH₂C≡CH), styrenyl methyl groups

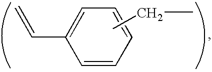

and the like.

Poly(arylene ether)s containing polymerizable groups include so-called capped poly(arylene ethers), in which at least one terminal phenolic hydroxy group of the poly(arylene ether) is functionalized with a polymerizable group. In some embodiments, the poly(arylene ether) is a monofunctional poly(arylene ether) having the structure

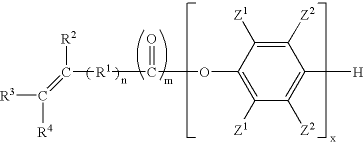

wherein Z¹ and Z² are defined above; x is about 50 to about 400, specifically about 100 to about 200; R¹ is C₁-C₁₂ hydrocarbylene; m and n are each independently 0 or 1 provided that m and n are not both 0; and R² and R³ and R⁴ are each independently hydrogen or C₁-C₁₈ hydrocarbyl. In some embodiments, each Z¹ is methyl, each Z² is hydrogen or methyl, m is 1, n is 0, R² is hydrogen or methyl, and R³ and R⁴ are hydrogen. In some embodiments, each Z¹ is methyl, each Z² is hydrogen or methyl, m is 0, n is 1, R¹ is methylene, and R² and R³ and R⁴ are hydrogen. In some embodiments, each Z¹ is methyl, each Z² is hydrogen or methyl, m is 0, n is 1, R¹ is

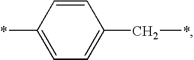

and R² and R³ and R⁴ are hydrogen. These monofunctional poly(arylene ether)s may be synthesized by oxidative polymerization of a monohydric phenol or a mixture of monohydric phenols, followed by capping with an appropriate polymerizable-group-containing capping agent. Suitable monohydric phenols are described in, for example, U.S. Pat. No. 3,306,875 to Hay. Suitable capping agents are known in the art and described in, for example, U.S. Pat. Nos. 4,562,243 to Percec and 6,384,176 to Braat et al., and U.S. Statutory Invention Registration No. H521 of Fan.

In some embodiments, the poly(arylene ether) is a bifunctional poly(arylene ether) having the structure

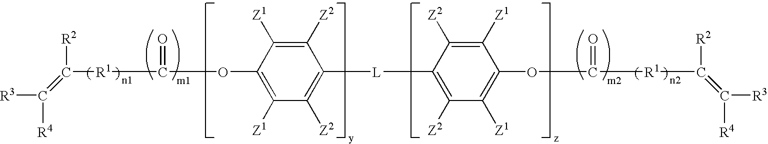

wherein Z¹ and Z² are as defined above; y and z are each independently about 25 to about 400 provided that the sum of y and z is at least 50; each occurrence of R¹ is independently C₁-C₁₂ hydrocarbylene; m¹, m², n¹, and n² are each independently 0 or 1 provided that m¹ and n¹ are not both 0, and m² and n² are not both 0; each occurrence of R², R³, and R⁴ is independently hydrogen or C₁-C₁₈ hydrocarbyl; and L has the structure

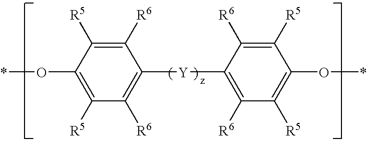

wherein each occurrence of R⁵ and R⁶ is independently selected from the group consisting of hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, and C₂-C₁₂ halohydrocarbyloxy wherein at least two carbon atoms separate the halogen and oxygen atoms; z is 0 or 1; and Y has a structure selected from the group consisting of

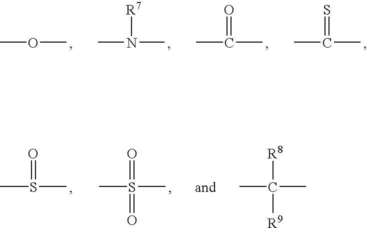

wherein each occurrence of R⁷ is independently selected from the group consisting of hydrogen and C₁-C₁₂ hydrocarbyl, and each occurrence of R⁸ and R⁹ is independently selected from the group consisting of hydrogen, C₁-C₁₂ hydrocarbyl, and C₁-C₆ hydrocarbylene wherein R⁸ and R⁹ collectively form a C₄-C₁₂ alkylene group. In some embodiments, each occurrence of Z¹ is methyl, each occurrence of Z² is hydrogen or methyl, each occurrence of R⁵ is methyl, each occurrence of R⁶ is hydrogen, z is 0 or 1, Y is isopropylidene, m¹ and m² are 1, n¹ and n² are 0, each occurrence of R² is independently hydrogen or methyl, and each occurrence of R³ and R⁴ is hydrogen. In some embodiments, each occurrence of Z¹ is methyl, each occurrence of Z² is hydrogen or methyl, each occurrence of R⁵ is methyl, each occurrence of R⁶ is hydrogen, z is 0 or 1, Y is isopropylidene, m¹ and m² are 0, n¹ and n² are 1, each occurrence of R¹ is methylene, and each occurrence of R² and R³ and R⁴ is hydrogen. In some embodiments, each occurrence of Z¹ is methyl, each Z² is hydrogen or methyl, each occurrence of R⁵ is methyl, each occurrence of R⁶ is hydrogen, z is 0 or 1, Y is isopropylidene, m¹ and m² are 0, n¹ and n² are 1, each occurrence of R¹ is

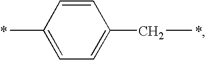

and each occurrence of R² and R³ and R⁴ is hydrogen. These bifunctional poly(arylene ether)s may be synthesized by oxidative copolymerization of a monohydric phenol and a dihydric phenol, followed by capping with an appropriate polymerizable-group-containing capping agent. Suitable dihydric phenols are described in co-pending U.S. application Ser. No. 11/272,119 of Carrillo et al., filed 10 Nov. 2005. Corresponding polyfunctional poly(arylene ether)s comprising 3 or more capping groups may be synthesized by oxidative copolymerization of a monohydric phenol and a polyhydric phenol (that is, compound comprising three or more phenolic hydroxy groups), followed by capping with an appropriate polymerizable-group-containing capping agent. Suitable polyhydric phenols are described in co-pending U.S. application Ser. No. 11/272,119 of Carrillo et al., filed 10 Nov. 2005.

The poly(arylene ether) can be a ring-functionalized poly(arylene ether). In some embodiments, the ring-functionalized poly(arylene ether) comprises repeating structural units of the formula

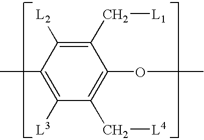

wherein each L¹-L⁴ is independently hydrogen, a C₁-C₁₂ alkyl group, an alkenyl group, or an alkynyl group; wherein the alkenyl group is represented by

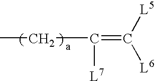

wherein L⁵-L⁷ are independently hydrogen or methyl, and a is 0, 1, 2, 3, or 4; wherein the alkynyl group is represented by

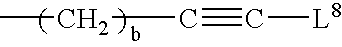

wherein L⁸ is hydrogen, methyl, or ethyl, and b is 0, 1, 2, 3, or 4; and wherein about 0.02 mole percent to about 25 mole percent of the total L¹-L⁴ substituents in the ring-functionalized poly(arylene ether) are alkenyl and/or alkynyl groups. The ring-functionalized poly(arylene ether) of this embodiment may be prepared according to known methods. For example, an unfunctionalized poly(arylene ether) such as poly(2,6-dimethyl-1,4-phenylene ether) may be metallized with a reagent such as n-butyl lithium and subsequently reacted with an alkenyl halide such as allyl bromide and/or an alkynyl halide such as propargyl bromide. This and other methods for preparation of ring-functionalized poly(arylene ether) resins are described, for example, in U.S. Pat. No. 4,923,932 to Katayose et al.

In some embodiments, the ring-functionalized poly(arylene ether) is the product of the melt reaction of a poly(arylene ether) and an α,β-unsaturated carbonyl compound or a β-hydroxy carbonyl compound. Examples of α,β-unsaturated carbonyl compounds include, for example, maleic anhydride, citriconic anhydride, and the like. Examples of β-hydroxy carbonyl compounds include, for example, citric acid, and the like. Such functionalization is typically carried out by melt mixing the poly(arylene ether) with the desired carbonyl compound at a temperature of about 190 to about 290° C.

In some embodiments, the poly(arylene ether) is free of the polymerizable groups described above. For example, the poly(arylene ether) may consist of the product of oxidative copolymerization of one or more monohydric phenols lacking polymerizable substituents. Suitable monohydric phenols are known in the art and include 2,6-dimethylphenol and 2,3,6-trimethylphenol. In addition to one or more monohydric phenols, the monomer may comprise one or more dihydric or polyhydric phenols lacking polymerizable substituents. Suitable dihydric and polyhydric phenols are described in co-pending U.S. application Ser. No. 11/272,119 of Carrillo et al., filed 10 Nov. 2005. In some embodiments, the poly(arylene ether) comprises 2,6-dimethyl-1,4-phenylene ether units, 2,3,6-trimethyl-1,4-phenylene ether units, or a combination thereof. In some embodiments, the poly(arylene ether) consists essentially of 2,6-dimethyl-1,4-phenylene ether units, 2,3,6-trimethyl-1,4-phenylene ether units, or a combination thereof.

In some embodiments, the poly(arylene ether) comprises 2,6-dimethyl-1,4-phenylene ether units, 2,3,6-trimethyl-1,4-phenylene ether units, 2-allyl-6-methyl-1,4-phenylene ether units, 2,6-dimethyl-3-allyl-1,4-phenylene ether units, 2,6-diallyl-1,4-phenylene ether units, or a combination thereof.

When the film is formed from a polymer melt (for example, by film extrusion), the composition may comprise the poly(arylene ether) in an amount of about 10 to 100 weight percent, based on the total weight of the composition. Specifically, the poly(arylene ether) amount may be about 50 to 100 weight percent, more specifically about 75 to 100 weight percent, still more specifically about 90 to 100 weight percent. When the film is formed from a solvent solution (for example, by spin coating or solvent casting), the composition may comprise the poly(arylene ether) in an amount of about 2 to about 50 weight percent, and the solvent in an amount of about 50 to about 98 weight percent, both based on the total weight of the composition. Within the range of about 2 to about 50 weight percent, the poly(arylene ether) amount may be specifically about 5 to about 35 weight percent, more specifically about 15 to about 30 weight percent. Within the range of about 50 to about 98 weight percent, the solvent amount may be specifically about 65 to about 95 weight percent, more specifically about 70 to about 85 weight percent.

When a solvent is employed in the film-forming composition, it generally is a good solvent for the poly(arylene ether). Good solvents for the poly(arylene ether) can, in some embodiments, have a Hildebrand solubility parameter of about 16 to about 23 megapascal^{1/2}. Within this range, the solubility parameter may be about 17 to about 21 megapascal^{1/2}. Methods for calculating Hildebrand solubility parameter values are known in the art, and values for various solvents are tabulated in, for example, Edward N. Peters, Chapter 20: Behavior in Solvents, in R. F. Brady, Jr., ed., Comprehensive Desk Reference of Polymer Characterization and Analysis. Oxford University Press: New York, 2003. A representative listing of Hildebrand solubility parameter values (that is, δ values), for various solvents is given below

| Material | δ (MPa^{1/2}) |
|---|---|
| Bromochloromethane | 18.8 |
| Toluene | 18.2 |
| Benzene | 18.8 |
| Ethylbenzene | 18.0 |
| o-xylene (1,2-dimethylbenzene) | 18.4 |
| m-xylene (1,3-dimethylbenzene) | 18.0 |
| p-xylene (1,4-dimethylbenzene) | 18.0 |
| mesitylene (1,3,5-trimethylbenzene) | 18.0 |
| Chloroform | 19.0 |
| Carbon tetrachloride | 17.6 |
| Chlorobenzene | 19.4 |
| Dioxane | 17.6 |

As a point of reference, poly(2,6-dimethyl-1,4-phenylene ether) has a Hildebrand solubility parameter of 19.0 MPa^{1/2}. The solvent will typically exclude substantial amounts of dichloromethane, bromochloromethane, and dibromomethane, because at least some poly(arylene ether)s are known to initially dissolve in these solvents, but subsequently precipitate. See, A. Factor, G. E. Heinsohn, and L. H. Vogt, J. Polym. Sci., Polym. Lett, volume 7, pages 205-209 (1969).

In addition to being a good solvent for the poly(arylene ether), the solvent generally has sufficient volatility to facilitate its removal but not so great a volatility that it disrupts the integrity of the film as solvent is removed (for example by forming bubbles). In some embodiments, the solvent has an atmospheric boiling point of about 40 to about 200° C., specifically about 50 to about 160° C., more specifically about 60 to about 120° C.

Suitable solvents include, for example, halogenated aliphatic hydrocarbon solvents, aromatic hydrocarbon solvents, halogenated aromatic hydrocarbon solvents, and mixtures thereof. Suitable halogenated aliphatic hydrocarbon solvents include trichloromethane, dichloroethanes, trichloroethanes, tetrachloroethanes, pentachloroethane, hexachloroethane, tribromomethane, dibromoethanes, and mixtures thereof. Suitable aromatic hydrocarbon solvents include benzene, nitrobenzene, toluene, ethylbenzene, xylenes, anisole, and mixtures thereof. Suitable halogenated aromatic hydrocarbon solvents include chlorobenzene, dichlorobenzenes, trichlorobenzenes, bromobenzene, dibromobenzenes, and mixtures thereof. In some embodiments, the solvent is chloroform, toluene, or a mixture thereof.

In addition to the poly(arylene ether) and the optional solvent, the film-forming composition may, optionally, further comprise an olefinically unsaturated monomer comprising at least two polymerizable groups. Such olefinically unsaturated monomers are sometimes referred to as crosslinking agents. Suitable classes of olefinically unsaturated monomers include, for example, acryloyl monomers, alkenyl aromatic monomers, allylic monomers, vinyl ethers, maleimides, and the like, and mixtures thereof. In some embodiments, the olefinically unsaturated monomer is selected from divinylbenzenes, diallylbenzenes, trivinylbenzenes, triallylbenzenes, divinyl phthalates, diallyl phthalates, triallylisocyanurate, divinylsiloxanes, and the like, and mixtures thereof. When the composition comprises an olefinically unsaturated monomer, it may be used in an amount of about 1 to about 50 weight percent, based on the weight of the poly(arylene ether). Within this range, the amount of olefinically unsaturated monomer may be specifically about 2 to about 35 weight percent, more specifically about 5 to about 20 weight percent.

The film-forming composition may, optionally, comprise a polymer other than the poly(arylene ether). Suitable polymers include, for example, polystyrenes (including atactic and syndiotactic polystyrenes), rubber-modified polystyrenes, poly(methylstyrene)s, styrene-acrylonitrile copolymers, polyethylenes, polypropylenes, acrylonitrile-butadiene-styrene terpolymers, poly(methyl methacrylate)s, and unhydrogenated or hydrogenated block copolymers of an alkenyl aromatic compound (for example, styrene) and a conjugated diene (for example, butadiene or isoprene). When present, such polymers may be used in an amount of about 2 to about 80 weight percent, specifically about 10 to about 50 weight percent, wherein all weight percents are based on the weight of the poly(arylene ether). In some embodiments, the film-forming composition excludes polymers other than the poly(arylene ether).

Although curing promoters such as organic peroxides are often used in thermal curing of poly(arylene ether)s, they have been found to have little or no beneficial effect and sometimes a detrimental effect when included in films that are cured by electron beam. Thus, in some embodiments, the film-forming composition does not comprise a curing promoter.

The film-forming composition may, optionally, comprise a filler. In order to promote compatibility between the poly(arylene ether) and the filler, the filler can be a hydrophobic filler. Hydrophobic fillers are known in the art and are prepared by treating the surface of an inorganic filler with a so-called coupling agent that covalently binds to the filler surface and includes a hydrophobic group. Suitable inorganic fillers include fused silica, fumed silica, and colloidal silica. The coupling agent may, optionally, include one or more of the polymerizable groups described above. Some specific examples of suitable hydrophobic fillers are the phenylsilane-treated silica having a mean particle size of 0.3 micrometers, a maximum particle size of 5 micrometers, and a surface area of 13.7 meters²/gram available as SE1050-SPL from Admatech; the vinylsilane-treated silica having a mean particle size of 0.3 micrometers, a maximum particle size of 5 micrometers, and a surface area of 13.7 meters²/gram available as SE1050-SFL from Admatech; the aminosilane-treated silica having a mean particle size of 0.3 micrometers, a maximum particle size of 5 micrometers, and a surface area of 13.7 meters²/gram available as SE1050-SAN from Admatech; the phenylsilane-treated silica having a mean particle size of 0.6 micrometers, a maximum particle size of 5 micrometers, and a surface area of 4 meters²/gram available as SE2050-SFE from Admatech; the vinylsilane-treated silica having a mean particle size of 0.6 micrometers, a maximum particle size of 5 micrometers, and a surface area of 4 meters²/gram available as SE2050-SPE from Admatech; the aminosilane-treated silica having a mean particle size of 0.6 micrometers, a maximum particle size of 5 micrometers, and a surface area of 4 meters²/gram available as SE2050-SAE from Admatech; the polydimethylsiloxane-treated silica having a surface area of 115 meters²/gram available as TS-720 from Cabot Corporation; the dimethyldichlorosilane-treated silica having a surface area of 125 meters²/gram available as TS-610 from Cabot Corporation; and the hexamethyldisilazane-treated silica having a surface area of 225 meters²/gram available as TS-530 from Cabot Corporation.

In some embodiments, the film-forming composition does not comprise a filler.

The film-forming composition may, optionally, further comprise one or more additives known in the art for thermoplastic and thermoset poly(arylene ether) compositions. Such additives include, for example, heat stabilizers, light stabilizers, mold release agents, processing aids, flame retardants, drip retardants, nucleating agents, UV blockers, dyes, pigments, colorants, antioxidants, plasticizers, lubricants, flow modifiers, antistatic agents, blowing agents, mineral oil, metal deactivators, antiblocking agents, processing aids, substrate adhesion agents, toughening agents, low-profile additives, stress-relief additives, and combinations thereof.

In some embodiments, the composition is free of components other than those described above as required or optional. For example, the composition used to form the poly(arylene ether) film may be free of electrically conductive materials. As another example, the composition used to form the poly(arylene ether) film may be free of phosphate ester crosslinking agents.

After the poly(arylene ether) film is formed, it is irradiated with a dosage of about 50 to about 50,000 kiloGrays of accelerated electrons to form a crosslinked poly(arylene ether) film. In some embodiments, the dosage is about 100 to about 20,000 kiloGrays, specifically about 500 to about 10,000 kiloGrays, more specifically about 1,000 to about 10,000 kiloGrays, even more specifically about 2,000 to about 10,000 kiloGrays. When the electron beam dosage is significantly less than 50 kiloGrays, the degree of crosslinking may be insufficient, and this may be manifested as insufficient heat resistance. When the electron beam dosage is significantly greater than 50,000 kiloGrays, excessive chain scission of the poly(arylene ether) may occur, and this may be manifested as a brittle film.

The accelerating voltage of the electrons will vary according to factors including the electron beam equipment used, the composition of the poly(arylene ether) film, the thickness of the poly(arylene ether) film, the desired degree of crosslinking, and the desired processing time. In some embodiments, the electrons are accelerated through a voltage of about 10 to about 10,000 kilovolts, specifically about 40 to about 1,000 kilovolts, more specifically about 80 to about 400 kilovolts, still more specifically about 80 to about 150 kilovolts. In some embodiments in which the poly(arylene ether) is a poly(2,6-dimethyl-1,4-phenylene ether), the dosage is about 1,000 to about 20,000 kiloGrays of accelerated electrons. In some embodiments in which the poly(arylene ether) is a poly(2,6-dimethyl-1,4-phenylene ether-co-2-allyl-6-methyl-1,4-phenylene ether), the dosage is about 500 to about 10,000 kiloGrays of accelerated electrons. In some embodiments, the electrons are accelerated through a voltage sufficient to cause at least 50% of the electrons to pass through the poly(arylene ether) film.

One embodiment is a method of preparing a crosslinked poly(arylene ether) film, comprising: solvent casting a composition comprising about 60 to about 90 weight percent chloroform, and about 10 to about 40 of a poly(2,6-dimethyl-1,4-phenylene ether-co-2-allyl-6-methyl-1,4-phenylene ether) having an intrinsic viscosity of about 0.35 to about 1 deciliter per gram measured at 25° C. in chloroform and a polydispersity index of about 2 to about 6 to form a poly(arylene ether) film; and irradiating the poly(arylene ether) film with a dosage of about 1,000 to about 10,000 kiloGrays of accelerated electrons. In some embodiments, the solvent casting composition further comprises about 0.5 to about 5 weight percent of an olefinically unsaturated monomer selected from the group consisting of divinylbenzenes, diallylbenzenes, trivinylbenzenes, triallylbenzenes, divinyl phthalates, diallyl phthalates, triallylisocyanurate, divinylsiloxanes, and mixtures thereof.

The invention includes crosslinked poly(arylene ether) films prepared by any of the above-described methods. One advantage of the crosslinked poly(arylene ether) films is their solvent resistance. An objective measure of solvent resistance and degree of crosslinking is gel content, which is a measure of the weight percent of a sample that remains undissolved after treatment with refluxing solvent. Thus, in some embodiments, the crosslinked poly(arylene ether) film has a gel content of at least 50 weight percent, measured according to ASTM D2765-01(2006) using a 24 hour Soxhlet extraction in refluxing chloroform. The gel content can be at least 60 weight percent, specifically at least 70 weight percent, more specifically at least 80 weight percent. In contrast, uncrosslinked poly(arylene ether) film is typically completely soluble in refluxing chloroform; that is, it would have a gel content of 0 weight percent in this test.

When the poly(arylene ether) comprises polymerizable groups, one measure of the extent of crosslinking is the percent of residual polymerizable groups after electron beam irradiation. For example, when the poly(arylene ether) comprises allyl groups, at least 5 percent of the allyl groups in the poly(arylene ether) are consumed upon the irradiation of the poly(arylene ether) film with accelerated electrons. Generally, the percent of polymerizable groups consumed may be at least 5 percent, more specifically at least 10 percent, still more specifically at least 20 percent, even more specifically at least 30 percent, yet more specifically at least 50 percent.

Another advantage of the crosslinking poly(arylene ether) films is their flexibility. In some embodiments, the films can be folded and unfolded without cracking. Specifically, the following procedure may be used to evaluate the “foldability” of the film. A sample of poly(arylene ether) film, before or after crosslinking, having dimensions 4 centimeters long by 2 centimeters wide by 35-45 micrometers thick is placed on a horizontal flat steel plate and folded by 180° along a line bisecting the length of the sample. Another steel plate is then carefully placed on top such that the steel plate on the top presses the folded film. The weight of the steel plate on top of the film is 1 kilogram and the size is 20 centimeters square. Thus a pressure of 245 pascals is exerted on the folded film. The steel plate at the top is removed after 1 minute. The film is then straightened (unfolded), laid flat on the bottom steel plate, and pressed again from the top by the upper steel plate, thereby applying a pressure of 245 pascals for 1 minute. The top plate is then carefully removed and the film is visually examined for any cracks. This process is repeated three times with different film samples of the same formulation. If no cracks are observed in any of the three test samples, the film is considered to have been folded and unfolded without cracking. That film will be rated as “Pass” in “Film Quality Test”.

The invention includes articles comprising the crosslinked poly(arylene ether) films. Such articles include printed wiring boards, multilayered laminates, and resin-coated copper foils.

The invention is further illustrated by the following non-limiting examples.

### EXAMPLES 1-4

Four poly(arylene ether) copolymers, designated “APPExx” where the numbered suffix represents the weight percent of 2-allyl-6-methylphenol in the monomer mixture (for example, “APPE10” refers to a copolymer prepared from monomer comprising 10 weight percent), were prepared by oxidative copolymerization of 2,6-dimethylphenol and 2-allyl-6-methylphenol using the following procedure. Nitrogen was flowed through a reactor maintained at 25° C. A monomer solution (3.4 kilograms) containing 50 weight percent toluene and 50 weight percent total of 2,6-dimethylphenol and 2-allyl-6-methylphenol was transferred to an addition vessel attached to the reactor. The reactor was charged with 7.5 weight percent of the monomer solution, di-n-butylamine (10 grams), dimethyl-n-butylamine (23.5 grams), oleyltrimethylammonium chloride (1 gram), N,N′-di-t-butylethylenediamine (1.5 grams), and an aqueous solution (7.5 grams) containing 6.5 weight percent copper (as Cu₂O) and 48 weight percent hydrobromic acid. The reactants were stirred, oxygen flow was initiated and controlled to maintain an oxygen concentration of less than 13% in the reaction headspace, and the remainder of the monomer solution was added over the course of 45 minutes. After about 70 minutes, the reactor temperature was increased to 47° C., and the oxygen concentration in the headspace was increased to 20%. When the desired extent of polymerization was reached (as determined, for example, by the viscosity of the reaction mixture), the reaction was terminated by stopping the oxygen flow and adding to the reaction mixture 4.2 grams of a 40 weight percent solution of trisodium nitrilotriacetate and 340 grams of water. The poly(arylene ether) copolymer was isolated by precipitation in methanol.

The copolymer prepared from a monomer mixture consisting of 90 weight percent 2,6-dimethylphenol and 10 weight percent 2-allyl-6-methylphenol had an intrinsic viscosity of 0.53 deciliter per gram, a weight average molecular weight of 66,467 atomic mass units, a number average molecular weight of 14,969 atomic mass units, and a polydispersity index of 4.44; it is designated APPE10 in Table 1. The copolymer prepared from a monomer mixture consisting of 85 weight percent 2,6-dimethylphenol and 15 weight percent 2-allyl-6-methylphenol had an intrinsic viscosity of 0.52 deciliter per gram, a weight average molecular weight of 59,788 atomic mass units, a number average molecular weight of 17,468 atomic mass units, and a polydispersity index of 3.42; it is designated APPE15 in Table 1. The copolymer prepared from a monomer mixture consisting of 80 weight percent 2,6-dimethylphenol and 20 weight percent 2-allyl-6-methylphenol had an intrinsic viscosity of 0.59 deciliter per gram, a weight average molecular weight of 71,025 atomic mass units, a number average molecular weight of 19,124 atomic mass units, and a polydispersity index of 3.71; it is designated APPE20 in Table 1. The copolymer prepared from a monomer mixture consisting of 65 weight percent 2,6-dimethylphenol and 35 weight percent 2-allyl-6-methylphenol had an intrinsic viscosity of 0.38 deciliter per gram, a weight average molecular weight of 37,625 atomic mass units, a number average molecular weight of 11,819 atomic mass units, and a polydispersity index of 3.18; it is designated APPE35 in Table 1. All poly(arylene ether)s were characterized by gel permeation chromatography (GPC), proton nuclear magnetic resonance spectroscopy (¹H NMR), carbon-13 nuclear magnetic resonance spectroscopy (¹³C NMR), and Fourier transform infrared spectroscopy (FTIR) techniques. The copolymers of 2,6-dimethylphenol and 2-allyl-6-methylphenol were determined to be random copolymers. The NMR and FTIR spectra of the two copolymers were qualitatively similar except for the intensity of peaks corresponding to the allyl groups.

The general procedure for preparing uncrosslinked films is as follows. A coating composition is prepared by mixing a poly(arylene ether) and a suitable solvent, sometimes in the presence of one or more of inorganic fillers, a crosslinlcer, and an organic peroxide. If a filler is used, it is typically added first to the solvent, and the mixture is shaken for about 1 to about 30 minutes to facilitate dispersion of the particles. A layer of the coating composition is then deposited onto a substrate (for example, a glass plate that had been washed alternately with deionized water and chloroform), which is maintained at a temperature that is more than 10° C. below the boiling point of the solvent to avoid bubble formation in the film. For example, when the solvent is chloroform, which has an atmospheric boiling point of about 62° C., the substrate may be maintained at 25° C. The film is vacuum dried at about 120° C. and about 25-250 millimeters of mercury absolute pressure for about 1 to about 5 hours. In order to ensure that the film is dry, the weight of the film is measured periodically, typically in one hour intervals. The film is considered dry when the weight loss in two successive measurements is less then 2%.

Uncrosslinked films of the four APPE materials were prepared using the above procedure with chloroform as the solvent and no added filler, crosslinker, or peroxide in the coating composition. The resulting uncrosslinked films were evaluated by the foldability test described above. The results, presented in Table 1, show that all four APPE materials produced uncrosslinled films that pass the foldability test (“Film Quality Test”).

TABLE 1

| | | | | | | Film Quality |
|---|---|---|---|---|---|---|
| | PPE type | IV (dl/g) | Mₙ | M_{w} | PDI | Test |
| Ex. 1 | APPE10 | 0.53 | 14969 | 66467 | 4.44 | Pass |
| Ex. 2 | APPE15 | 0.52 | 17468 | 59788 | 3.42 | Pass |
| Ex. 3 | APPE20 | 0.59 | 19124 | 71025 | 3.71 | Pass |
| Ex. 4 | APPE35 | 0.38 | 11819 | 37625 | 3.18 | Pass |

### COMPARATIVE EXAMPLES 1-4

The APPE35 of Example 4 was redistributed with tetramethyl bisphenol A (TMBPA). The procedure was carried out as follows. After 15 grams of APPE35 was dissolved in 90 grams of toluene, the TMBPA was added in the amount specified in Table 2 and completely dissolved. Then, benzoyl peroxide (BPO) was added in the amount specified in Table 2. After one hour at 90° C., the solution was cooled below 30° C. and the product was precipitated in methanol to obtain a lower intrinsic viscosity polymer. The precipitated polymer was dried in a vacuum oven at 120° C. for 4-6 hours. All four products had intrinsic viscosities of 0.24 dL/g or less. Uncrosslinked films were prepared as described for Examples 1-4 by dissolving solids in chloroform at 20% by weight. The resulting films were evaluated by the foldability test. The results, presented in Table 2, show that all four samples failed the foldability test (Film Quality Test).

TABLE 2

| | | BPO | | | | | | |
|---|---|---|---|---|---|---|---|---|
| | TMBPA | (wt % | | | | | Film | |
| | (wt % of | of | | | IV | | Quality | |
| | resin) | resin) | Mₙ | M_{w} | (dL/g) | PDI | Test | Comments |
| C. Ex. 1 | 5 | 5.6 | 5969 | 33143 | 0.24 | 5.55 | Fail | Film brittle and crumbled when folded |
| C. Ex. 2 | 10 | 11.3 | 4647 | 24360 | 0.18 | 5.24 | Fail | Film brittle and crumbled when folded |
| C. Ex. 3 | 15 | 16.9 | 4106 | 21103 | 0.15 | 5.14 | Fail | No film formation. Powder remains after solvent |
| | | | | | | | | evaporation and it comes off when peeled |
| C. Ex. 4 | 10 | 7.5 | 4604 | 27557 | 0.21 | 5.99 | Fail | Film brittle and crumbled on handling |

### EXAMPLES 5-17

In these examples, crosslinked films are prepared by treating uncrosslinked films with accelerated electrons. A poly(arylene ether) homopolymer, poly(2,6-dimethyl-1,4-phenylene ether), having an intrinsic viscosity of 0.46 deciliter per gram measured in chloroform at 25° C. was obtained as PPO* 646 from GE Plastics. This poly(arylene ether) homopolymer is designated “PPE” in Table 3. An apparatus suitable for electron beam crosslinking is the Application Development Unit available from Advanced Electron Beam Inc. The electrons may be accelerated through about 80 to about 150 kilovolts (kV). The depth of penetration without any attenuation of dosage for a unit density is about 80 micrometers under these conditions. When, for example, the films are about 40 micrometers thick and have a specific gravity of about 1.08 grams per milliliter, the electron beam fully penetrates the film without any significant lowering of dosage. The single pass dosage is up to 75 kiloGrays and total dosage may be varied between about 50 and about 10,000 kiloGrays (kGy).

For these experiments, coating compositions were prepared by mixing 20 percent by weight of a poly(arylene ether) with 80 percent by weight of chloroform at 23° C. and agitating to dissolve the poly(arylene ether). The polymer films were cast using a Gardco AP-15SS film applicator. The nominal applicator path depth for the film was 7 mils (178 micrometers); the actual wet film thickness was not determined. The residual solvent was stripped off under vacuum at 120° C. for three hours. The dry thickness of the film was about 40 micrometers for all films. The films were then subjected to varying dosages of the electron beam.

The gel content of these films was determined and the results are presented in Table 3. Gel content was used as one indication of the degree of the crosslinking of the films. Gel contents were determined according to ASTM D 2765-01 (2006), “Standard Test Methods for Determination of Gel Content and Swell Ratio of Crosslinked Ethylene Plastics”, Method A, substituting the electron beam-cured films for the crosslinked ethylene plastics of the method title, and using chloroform as the extraction solvent. Briefly, gel content is the weight percent of the sample that cannot be dissolved in a 24 hour Soxhlet extraction with refluxing chloroform as the solvent. After Soxhlet extraction and before being weighed, the remaining film sample was dried at 130° C. under 710-740 millimeters mercury vacuum to constant weight. Gel content is calculated according to the equation

gel %=100*(w₂/w₁)

wherein “gel %” is the gel content in weight percent, w₁ is the initial weight of the sample, and w₂ is the weight of the sample after Soxhlet extraction and drying. Higher gel content values correspond to higher degrees of crosslinking.

The degree of crosslinking in the films was characterized by FTIR. The allyl groups in the copolymer APPE showed a characteristic infrared absorption at 914 reciprocal centimeters (cm⁻¹) while the 2,6-dimethylphenyl ether groups in the copolymer showed a characteristic infrared absorption at 831 cm⁻¹. A ratio of the peak height of the allyl groups to that of the 2,6-dimethylphenyl ether groups was used to determine the allyl content of a copolymer. A calibration chart was constructed by measuring the allyl monomer content of three standards using ¹H, NMR and correlating it with the peak ratio by FTIR method. The progress of curing was tracked by measuring the uncured allyl groups in a copolymer as a fraction of allyl groups before curing using the calibration chart as shown below in Table 3.

TABLE 3

| | Mol % | | | |
|---|---|---|---|---|
| | allylated | Infrared | | |
| | comonomer by | Absorbance | Infrared Absorbance | Ratio |
| Sample | ¹H NMR | at 914 cm⁻¹ | at 831 cm⁻¹ | 914/831 |
| PPE | 0 | 0.002 | 1.663 | 0.001 |
| APPE10 | 7.46 | 0.159 | 1.043 | 0.152 |
| APPE15 | 12.45 | 0.264 | 0.97 | 0.272 |
| APPE20 | 15.91 | 0.366 | 0.994 | 0.368 |
| APPE35 | 28.88 | 0.586 | 0.843 | 0.695 |

The percent allyl crosslinking is defined according to the equation

$$\% \_allyl \_crosslinking = 100 * [ 1 - \frac{residual\_mole \% \_allyl \_groups}{initial\_mole \% \_allyl \_groups} ]$$

where residual_mole %_allyl_groups is the mole percent of phenylene ether repeat units comprising an allyl group before electron beam treatment, and initial_mole %_allyl_groups is the mole percent of phenylene ether repeat units comprising an allyl group after electron beam treatment.

A summary of the FTIR analyses for the film compositions is presented in Table 4. The results for Examples 5-7, representing irradiation of a poly(2,6-dimethyl-1,4-phenylene ether) film, show that a dosage of 1400 kiloGrays produced negligible crosslinking of the film, as indicated by gel content measurements. However, a dosage of 4000 kiloGrays was sufficient to extensively crosslink the film, as indicated by a gel content of 83.5%. The results for Examples 8-12, representing irradiation of a film of poly(arylene ether) prepared from 85 weight percent 2,6-dimethylphenol and 15 weight percent 2-allyl-6-methylphenol, show that substantial crosslinking occurred with dosages as low as 1200 kiloGrays (see Example 10 with a dosage of 1200 kiloGrays, a 77.7% gel content, and 7.3% allyl crosslinking). Higher dosages resulted in increased crosslinking (see Examples 11 and 12 with a dosages of 4000 and 6000 kiloGrays, respectively, and allyl crosslinking percents of 30.8 and 64.7%, respectively). The results for Examples 13-17, representing irradiation of a film of poly(arylene ether) prepared from 65 weight percent 2,6-dimethylphenol and 35 weight percent 2-allyl-6-methylphenol, are qualitatively similar to those of Examples 8-12, indicating that there may be diminishing returns for incorporating much more than 15 weight percent allylated monomer in the poly(arylene ether) used to prepare the poly(arylene ether) film.

TABLE 4

| | Ex. 5 | Ex. 6 | Ex. 7 |
|---|---|---|---|
| Poly(arylene ether) type | PPE | PPE | PPE |
| Poly(arylene ether) IV | 0.46 | 0.46 | 0.46 |
| (dL/g) | | | |
| Dosage (kGy) | 200 | 1400 | 4000 |
| Gel Content (%) | <10% | <10% | 83.5 |
| Mole percent allyl groups | — | — | — |
| (%) | | | |
| Percent allyl crosslinking | — | — | — |
| (%) | | | |

| | Ex. 8 | Ex. 9 | Ex. 10 | Ex. 11 | Ex. 12 |
|---|---|---|---|---|---|
| Poly(arylene ether) type | APPE15 | APPE15 | APPE15 | APPE15 | APPE15 |
| Poly(arylene ether) IV | 0.52 | 0.52 | 0.52 | 0.52 | 0.52 |
| (dL/g) | | | | | |
| Dosage (kGy) | 0 | 200 | 1200 | 4000 | 6000 |
| Gel Content (%) | — | <10% | 77.7 | 91.8 | — |
| Mole percent allyl groups | 12.2 | 12.6 | 11.3 | 8.4 | 4.3 |
| (%) | | | | | |
| Percent allyl crosslinking | 0.0 | 0.0 | 7.3 | 30.8 | 64.7 |
| (%) | | | | | |
| | Ex. 13 | Ex. 14 | Ex. 15 | Ex. 16 | Ex. 17 |
| Poly(arylene ether) type | APPE35 | APPE35 | APPE35 | APPE35 | APPE35 |
| Poly(arylene ether) IV | 0.38 | 0.38 | 0.38 | 0.38 | 0.38 |
| (dL/g) | | | | | |
| Dosage (kGy) | 0 | 200 | 1200 | 4000 | 6000 |
| Gel Content (%) | — | <10% | 82.5% | 92.8% | — |
| Mole percent allyl groups | 31.0 | 30.2 | 28.0 | 23.9 | 20.0 |
| (%) | | | | | |
| Percent allyl crosslinking | 0.0 | 2.8 | 9.9 | 23.0 | 35.4 |
| (%) | | | | | |

### EXAMPLES 18-25

Two poly(arylene ether) compositions were prepared by mixing a poly(arylene ether) copolymer and an olefinically unsaturated monomer in chloroform. Table 5 shows their compositions. Two olefinically unsaturated monomers were used: diallyl phthalate (“DAP” in Table 5), and triallyl isocyanurate (“TAIC” in Table 5).

The films were prepared using the procedure described for Examples 5-17. The films were then subjected to the varying dosages of electron beam, and gel content and percent allyl crosslinking were determined. The results are summarized in Table 5.

A comparison of the gel content values presented in Table 5 with those in Table 4 indicates that the use of olefinically unsaturated monomer has a fairly small effect on the gel content of the cured films (for example, gel contents of 77.3% (with diallyl phthalate) and 77.7% (without diallyl phthalate) at 1200 kiloGrays irradiation of the APPE15 samples; 93.5% (with diallyl phthalate) and 91.8% (without diallyl phthalate) at 4000 kiloGrays irradiation of the APPE15 samples; 87.3% (with triallyl isocyanurate) and 77.7% (without triallyl isocyanurate) at 1200 kiloGrays irradiation of the APPE15 samples; and 91.7% (with triallyl isocyanurate) and 91.8% (without triallyl isocyanurate) at 4000 kiloGrays irradiation of the APPE15 samples). Larger differences were observed for the percent allyl crosslinking values, with samples containing crosslink enhancer showing substantially higher values than samples without crosslinking enhancer when compared at the same dosage (for example, percent allyl crosslinking values of 11.1% (with diallyl phthalate) and 0.0% (without diallyl phthalate) for 200 kiloGrays irradiation of the APPE15 samples; 23.2% (with diallyl phthalate) and 7.3% (without diallyl phthalate) for 1200 kiloGrays irradiation of the APPE15 samples; 49.7% (with diallyl phthalate) and 30.8% (without diallyl phthalate) for 4000 kiloGrays irradiation of the APPE15 samples; 8.3% (with triallyl isocyanurate) and 0% (without triallyl isocyanurate) for 200 kiloGrays irradiation of the APPE15 samples, 29.3% (with triallyl isocyanurate) and 7.3% (without triallyl isocyanurate) for 1200 kiloGrays irradiation of the APPE15 samples, and 64.5% (with triallyl isocyanurate) and 30.8% (without triallyl isocyanurate) for 4000 kiloGrays irradiation of the APPE15 samples).

TABLE 5

| | Ex. 18 | Ex. 19 | Ex. 20 | Ex. 21 |
|---|---|---|---|---|
| APPE15 (wt %) | 19.7 | 19.7 | 19.7 | 19.7 |
| APPE35 (wt %) | 0 | 0 | 0 | 0 |
| Diallyl phthalate (wt %) | 1.4 | 1.4 | 1.4 | 1.4 |
| Triallyl isocyanurate (wt %) | 0 | 0 | 0 | 0 |
| Chloroform amount (wt %) | 78.9 | 78.9 | 78.9 | 78.9 |
| Dosage (kGy) | 0 | 200 | 1200 | 4000 |
| Gel content (%) | — | <10 | 77.3 | 93.5 |
| Mole percent allyl groups (%) | 12.9 | 11.5 | 9.9 | 6.5 |
| Percent allyl crosslinking (%) | 0.0 | 11.1 | 23.2 | 49.7 |
| | Ex. 22 | Ex. 23 | Ex. 24 | Ex. 25 |
| APPE15 (wt %) | 19.5 | 19.5 | 19.5 | 19.5 |
| APPE35 (wt %) | 0 | 0 | 0 | 0 |
| Diallyl phthalate (wt %) | 0 | 0 | 0 | 0 |
| Triallyl isocyanurate (wt %) | 2.5 | 2.5 | 2.5 | 2.5 |
| Chloroform amount (wt %) | 78.0 | 78.0 | 78.0 | 78.0 |
| Dosage (kGy) | 0 | 200 | 1200 | 4000 |
| Gel content (%) | — | <10 | 87.3 | 91.7 |
| Mole percent allyl groups (%) | 15.1 | 13.9 | 10.7 | 5.4 |
| Percent allyl crosslinking (%) | 0.0 | 8.3 | 29.3 | 64.5 |

### EXAMPLES 26-29

In crosslinking of polymers by thermochemical methods, an organic peroxide is often used as an initiator. Examples 26-29 each used a coating formulation containing an organic peroxide as shown in Table 6. The peroxide used was 2,5-bis-(tert-butylperoxy)-2,5-dimethyl-3′-hexane. The poly(arylene ether) used was APPE35. The film of this formulation was cast, dried, and exposed to an electron beam as in Examples 5-17.

Gel content values and percent allyl crosslinking values are presented in Table 4. A comparison of the gel content values in Table 6 and Table 4 shows small but consistent differences indicating lower gel content values for Table 6 compositions containing peroxide compared to Table 4 compositions without peroxide. The same is true for the percent allyl crosslinking values. These results suggest that the organic peroxide mildly inhibits the electron beam cure, in contrast to its role as a thermal curing promoter.

TABLE 6

| | Ex. 26 | Ex. 27 | Ex. 28 | Ex. 29 |
|---|---|---|---|---|
| APPE35 (wt %) | 19.8 | 19.8 | 19.8 | 19.8 |
| Organic peroxide amount (wt %) | 0.8 | 0.8 | 0.8 | 0.8 |
| Chloroform amount (wt %) | 79.4 | 79.4 | 79.4 | 79.4 |
| Dosage (kGy) | 0 | 200 | 1200 | 4000 |
| Gel content (%) | — | <10 | 79.9 | 89.7 |
| Mole percent allyl groups (%) | 31.1 | 30.4 | 29.2 | 24.2 |
| Percent allyl crosslinking (%) | 0.0 | 2.1 | 4.1 | 17.0 |

### COMPARATIVE EXAMPLES 5-13

In crosslinking of polymers by thermal methods, typically an organic peroxide is used as an initiator. Various grades of poly(2,6-dimethylphenol-co-2-allyl-6-methylphenol) namely, APPE10 and APPE20 that contain 10 and 20 weight percent, respectively, of the allylated comonomer were made in the laboratory. Several formulations were prepared containing varying levels of organic peroxide, which is 2,5-bis-(t-butyl peroxy)-2,5-dimethyl-3-hexane in this case. The films of these compositions were solvent caste, vacuum dried, and cured for 2-3 hours in a vacuum oven under 25-125 millimeters mercury absolute pressure swept by N₂ and at various temperatures indicated in Table 7. The gel content and allyl group crosslinking of the cured film were then measured. Results are presented in Table 7. A comparison of the results in Table 7 with those in Table 4 shows comparable levels of allyl group crosslinking and gel content by e-beam method (Table 4) compared to the conventional thermochemical means of crosslinking (Table 7). The electron beam method, however, has the advantage of less time required to effect the curing.

TABLE 7

| | C. Ex. 1 | C. Ex. 2 | C. Ex. 3 | C. Ex. 4 | C. Ex. 5 | C. Ex. 6 | C. Ex. 7 | C. Ex. 8 |
|---|---|---|---|---|---|---|---|---|
| APPE10 (wt %) | — | — | — | — | 19.9 | 19.8 | — | — |
| APPE15 (wt %) | 19.9 | 19.9 | 19.9 | 19.8 | — | — | — | — |
| APPE20 (wt %) | — | — | — | — | — | — | 19.8 | 19.9 |
| Organic peroxide (wt %) | 0.6 | 0.6 | 0.6 | 1 | 0.6 | 1 | 1 | 0.6 |
| Chloroform (wt %) | 79.5 | 79.5 | 79.5 | 79.2 | 79.5 | 79.2 | 79.2 | 79.5 |
| Curing temperature (° C.) | 200 | 225 | 250 | 225 | 225 | 225 | 225 | 225 |
| Curing time (hours) | 2 | 2 | 2 | 2 | 3 | 2 | 2 | 3 |
| Gel content (%) | 79.6 | 96.9 | 95 | — | 96.3 | — | — | 98.3 |
| Percent allyl crosslinking | — | — | — | 57.9 | | 63.2 | 58.5 | — |

### EXAMPLES 30-47

These examples illustrate the use of hydrophobic fillers in the crosslinked poly(arylene ether) films. Fillers are often used to lower the coefficient of thermal expansion of a film. However, successful incorporation of fillers in thin films presents some challenges. First, the characteristic size of the filler particles/agglomerates should preferably be less than one-fifth to one-tenth the thickness of the film. Second, the filler particles need to be well dispersed in the solvent under the mixing conditions. An effective way to satisfy the latter criterion is to surface-modify the filler particles to make them hydrophobic, which facilitates their dispersion in organic solvents. Silica particles treated with various kinds of silanes were used to achieve good dispersion in the examples detailed below. Formulations consisting of APPE15 along with various types of fillers and crosslinkers were prepared. The films of these compositions were solvent caste, vacuum dried, and cured for 2-3 hours in a vacuum oven under 25-125 millimeters mercury absolute pressure swept by N₂. In Table 8, “Vinyl Si” refers to a vinylsilane-treated silica obtained as SE1050-SFL from Admatech, “Phenyl Si” refers to phenylsilane-treated silica obtained as SE1050-SPL from Admatech, “TMS Si” refers to hexamethyldisilazane-treated silica obtained as TS-530 from Cabot Corporation, and “TAIC” refers to triallyl cyanurate.

When the properties of filled films of Table 8 are compared with those of the unfilled films in Tables 4 and 5, a few inferences may be drawn. First, there does not appear to be a very significant difference between the gel content of the cured films for the three types of silica used although there are small differences in percent allyl crosslinking. ‘Vinyl Si’ has crosslinkable vinyl groups attached to the surface of the silica particles and it was expected to yield higher degree of crosslinking at lower dosages. While not wishing to be bound by any particular mechanism, the present inventors speculate that the phenylsilane-treated silica and the hexamethyldisilazane-treated silica may have crosslinked with matrix through phenyl and methyl groups, respectively, under the conditions of electron beam curing. Second, both the gel content and the percent allyl crosslinking appear to be higher when TAIC is used, especially at low dosages, for instance in Example 45 compared to Examples 32, 37, and 41. It is clear that the use of olefinically unsaturated monomers such as TAIC results in high degree of crosslinking even at lower dosages. This is a finding of great practical significance.

TABLE 8

| | Ex. 30 | Ex. 31 | Ex. 32 | Ex. 33 | Ex. 34 | Ex. 35 | Ex. 36 | Ex. 37 | Ex. 38 |
|---|---|---|---|---|---|---|---|---|---|
| APPE15 (wt %) | 17.8 | 17.8 | 17.8 | 17.8 | 17.8 | 17.8 | 17.8 | 17.8 | 17.8 |
| Filler type | Vinyl Si | Vinyl Si | Vinyl Si | Vinyl Si | Vinyl Si | Phenyl Si | Phenyl Si | Phenyl Si | Phenyl Si |
| Filler loading (wt %) | 8.0 | 8.0 | 8.0 | 8.0 | 8.0 | 8.0 | 8.0 | 8.0 | 8.0 |
| Crosslinker type | — | — | — | — | — | — | — | — | — |
| Crosslinker (wt %) | — | — | — | — | — | — | — | — | — |
| Chloroform (wt %) | 74.2 | 74.2 | 74.2 | 74.2 | 74.2 | 74.2 | 74.2 | 74.2 | 74.2 |
| Dosage (kGy) | 0 | 200 | 1200 | 4000 | 6000 | 0 | 200 | 1200 | 4000 |
| Gel content (%) | — | — | 86.6 | 96.2 | — | — | — | 86.1 | 96.6 |
| Mole % allyl groups | 10.1 | 9.2 | 8.1 | 4.6 | 3.0 | 10.4 | 9.2 | 7.6 | 4.5 |
| % allyl crosslinking | 0.0 | 9.3 | 19.9 | 54.0 | 69.9 | 0.0 | 10.8 | 26.3 | 56.9 |
| | Ex. 39 | Ex. 40 | Ex. 41 | Ex. 42 | Ex. 43 | Ex. 44 | Ex. 45 | Ex. 46 | Ex. 47 |
| APPE15 (wt %) | 17.8 | 17.8 | 17.8 | 17.8 | 17.9 | 17.9 | 17.9 | 17.9 | 17.9 |
| Filler type | TMS Si | TMS Si | TMS Si | TMS Si | Vinyl Si | Vinyl Si | Vinyl Si | Vinyl Si | Vinyl Si |
| Filler loading (wt %) | 8.0 | 8.0 | 8.0 | 8.0 | 8.0 | 8.0 | 8.0 | 8.0 | 8.0 |
| Crosslinker type | — | — | — | — | TAIC | TAIC | TAIC | TAIC | TAIC |
| Crosslinker (wt %) | — | — | — | — | 2.6 | 2.6 | 2.6 | 2.6 | 2.6 |
| Chloroform (wt %) | 74.2 | 74.2 | 74.2 | 74.2 | 71.5 | 71.5 | 71.5 | 71.5 | 71.5 |
| Dosage (kGy) | 0 | 200 | 1200 | 4000 | 0 | 200 | 1200 | 4000 | 6000 |
| Gel content (%) | — | — | 85.3 | 94.8 | — | — | 91.2 | 96.5 | 97.9 |
| Mole % allyl groups | 13.0 | 12.6 | 10.4 | 7.3 | 12.2 | 11.5 | 8.3 | 5.6 | 4.0 |
| % allyl crosslinking | 0.0 | 3.1 | 19.9 | 44.2 | 0.0 | 6.2 | 32.1 | 54.0 | 67.2 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A method of preparing a crosslinked poly(arylene ether) film, comprising:
forming a poly(arylene ether) film from a composition comprising a poly(arylene ether) having an intrinsic viscosity of at least 0.25 deciliter per gram measured at 25° C. in chloroform, and a polydispersity index less than or equal to 10; and
irradiating the poly(arylene ether) film with a dosage of about 50 to about 50,000 kiloGrays of accelerated electrons to form a crosslinked poly(arylene ether) film.

2. The method of claim 1, wherein said forming a film comprises using a method selected from the group consisting of melt extrusion, solvent casting, spin coating, roller coating, dipping, and spraying.

3. The method of claim 1, wherein the crosslinked poly(arylene ether) film has a gel content of at least 50 weight percent, measured according to ASTM D2765 using a 24 hour Soxhlet extraction in refluxing chloroform.

4. The method of claim 1, wherein the crosslinked poly(arylene ether) film has a thickness of about 1 to about 1,000 micrometers.

5. The method of claim 1, wherein the electrons are accelerated through a voltage of about 10 to about 10,000 kilovolts.

6. The method of claim 1, wherein the poly(arylene ether) comprises repeating units selected from the group consisting of 2,6-dimethyl-1,4-phenylene ether units, 2,3,6-trimethyl-1,4-phenylene ether units, 2-allyl-6-methyl-1,4-phenylene ether units, 2,6-dimethyl-3-allyl-1,4-phenylene ether units, 2,6-diallyl-1,4-phenylene ether units, and combinations thereof.

7. The method of claim 1, wherein the poly(arylene ether) comprises at least one polymerizable group selected from the group consisting of acryloyl, methacryloyl, vinyl, allyl, and styrenyl methyl.

8. The method of claim 1, wherein the poly(arylene ether) has an intrinsic viscosity of 0.25 to about 1 deciliter per gram.

9. The method of claim 1, wherein the poly(arylene ether) has a polydispersity index of about 2 to about 6.

10. The method of claim 1, wherein the poly(arylene ether) is a poly(2,6-dimethyl-1,4-phenylene ether), and the dosage is about 1,000 to about 20,000 kiloGrays of accelerated electrons.

11. The method of claim 1, wherein the poly(arylene ether) is a poly(2,6-dimethyl-1,4-phenylene ether-co-2-allyl-6-methyl-1,4-phenylene ether), and the dosage is about 500 to about 10,000 kiloGrays of accelerated electrons.

12. The method of claim 10, wherein at least 5 percent of the allyl groups in the poly(arylene ether) are consumed upon the irradiation of the poly(arylene ether) film with accelerated electrons.

13. The method of claim 1, wherein the composition further comprises a solvent having a Hildebrand solubility parameter of about 16 to about 23 megapascal^{1/2} and an atmospheric boiling point of about 40 to about 200° C. provided that the solvent does not comprise dichloromethane, bromochloromethane, or dibromomethane.

14. The method of claim 1, wherein the composition further comprises a solvent selected from the group consisting of halogenated aliphatic hydrocarbon solvents, aromatic hydrocarbon solvents, halogenated aromatic hydrocarbon solvents, and mixtures thereof.

15. The method of claim 1, wherein the composition further comprises a solvent selected from the group consisting of chloroform, toluene, and mixtures thereof.

16. The method of claim 1, wherein the composition further comprises an olefinically unsaturated monomer comprising at least two polymerizable groups.

17. The method of claim 16, wherein the olefinically unsaturated monomer is selected from the group consisting of acryloyl monomers, alkenyl aromatic monomers, allylic monomers, vinyl ethers, maleimides, and mixtures thereof.

18. The method of claim 16, wherein the olefinically unsaturated monomer is selected from the group consisting of divinylbenzenes, diallylbenzenes, trivinylbenzenes, triallylbenzenes, divinyl phthalates, diallyl phthalates, triallylisocyanurate, divinylsiloxanes, and mixtures thereof.

19. The method of claim 1, wherein the composition ftutber comprises a polymer selected from the group consisting of polystyrene, rubber-modified polystyrene, poly(methylstyrene)s, styrene-acrylonitrile copolymers, polyethylenes, polypropylenes, acrylonitrile-butadiene-styrene terpolymers, poly(methyl methacrylate)s, and block copolymers of an alkenyl aromatic compound and a conjugated diene.

20. The method of claim 1, wherein the composition does not comprise a curing promoter.

21. The method of claim 1, wherein the composition further comprises a filler.

22. The method of claim 1, wherein the composition further comprises a hydrophobic filler.

23. The method of claim 1, wherein the composition further comprises a hydrophobic filler comprising polymerizable groups.

24. The method of claim 1, wherein the composition does not comprise a filler.

25. The method of claim 1, wherein the composition further comprises an additive selected from the group consisting of heat stabilizers, light stabilizers, mold release agents, processing aids, flame retardants, drip retardants, nucleating agents, UV blockers, dyes, pigments, colorants, antioxidants, plasticizers, lubricants, flow modifiers, antistatic agents, blowing agents, mineral oil, metal deactivators, antiblocking agents, processing aids, substrate adhesion agents, toughening agents, low-profile additives, stress-relief additives, and combinations thereof.

26. A method of preparing a crosslinked poly(arylene ether) film, comprising:
solvent casting a composition comprising
about 60 to about 90 weight percent chloroform, and
about 10 to about 40 of a poly(2,6-dimethyl-1,4-phenylene ether-co-2-allyl-6-methyl-1,4-phenylene ether) having an intrinsic viscosity of about 0.35 to about 1 deciliter per gram measured at 25° C. in chloroform and a polydispersity index of about 2 to about 6
to form a poly(arylene ether) film; and
irradiating the poly(arylene ether) film with a dosage of about 1,000 to about 10,000 kiloGrays of accelerated electrons.

27. The method of claim 26, wherein the solvent casting composition further comprises about 0.5 to about 5 weight percent of an olefinically unsaturated monomer selected from the group consisting of divinylbenzenes, diallylbenzenes, trivinylbenzenes, triallylbenzenes, divinyl phthalates, diallyl phthalates, triallylisocyanurate, divinylsiloxanes, and mixtures thereof.

28. A crosslinled poly(arylene ether) film prepared by the method of claim 1.

29. The crosslinked poly(arylene ether) film of claim 28, wherein the film can be folded and unfolded without cracking.

30. A crosslinked poly(arylene ether) film prepared by the method of claim 26.

31. A crosslinked poly(arylene ether) film prepared by the method of claim 27.

32. An article comprising a crosslinked poly(arylene ether) film prepared by the method of claim 1.

33. An article comprising a crosslinked poly(arylene ether) film prepared by the method of claim 1, wherein the article is selected from the group consisting of printed wiring boards, multilayered laminates, and resin-coated copper foils.
